(19) United States
(12) Patent Application Publication
(10) Pub. No.: US 2024/0386651 A1
(43) Pub. Date: Nov. 21, 2024

(54) MEMORY-EFFICIENT VOLUME DATA STRUCTURES FOR NOVEL VIEWPOINT RENDERING

(71) Applicant: Lemon Inc., Grand Cayman (KY)

(72) Inventors: Celong Liu, Los Angeles, CA (US); Xing Mei, Los Angeles, CA (US)

(21) Appl. No.: 18/317,818

(22) Filed: May 15, 2023

(51) Int. Cl. G06T 15/08

(52) U.S. Cl. CPC G06T 15/08; G06T 2207/20081; G06T 2207/20084

(57) ABSTRACT

Examples of memory-efficient volume data structures for novel view rendering are provided. In one aspect, a computing device for rendering a model volume data structure is provided. The computing device comprises a processor coupled to a storage medium that stores instructions, which, upon execution by the processor, cause the processor to store the model volume data structure, wherein the model volume data structure comprises a B+ tree graph, determine a camera view in which to render the model volume data structure, determine a plurality of rays in three-dimensional space based on the camera view, for each ray in the plurality of rays, perform a ray-marching process using the model volume data structure to determine a plurality of color features, and render the model volume data structure using the pluralities of color features.

### BACKGROUND

Neural radiance fields (NeRFs) are a class of machine learning techniques that generate three-dimensional (3D) representations of an object or scene using two-dimensional (2D) images of the object or scene to be rendered. The 2D images are often images of the object or scene from various viewpoints. The machine learning model utilizes deep learning techniques to train and enable rendering of the object or scene from a novel viewpoint, such as an unobserved viewpoint from the input of 2D images. Such techniques can be implemented for various applications dealing with digital assets, including but not limited to augmented reality/virtual reality (AR/VR), video games, and cinematic media.

### SUMMARY

Examples of memory-efficient volume data structures for novel view rendering are provided. In one aspect, a computing device for rendering a model volume data structure is provided. The computing device comprises a processor coupled to a storage medium that stores instructions, which, upon execution by the processor, cause the processor to store the model volume data structure, wherein the model volume data structure comprises a B+ tree graph, determine a camera view in which to render the model volume data structure, determine a plurality of rays in three-dimensional space based on the camera view, for each ray in the plurality of rays, perform a ray-marching process using the model volume data structure to determine a plurality of color features, and render the model volume data structure using the pluralities of color features.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example computing system for training and rendering novel viewpoints from two-dimensional images.

FIG. 2 shows an example model for implementing and training a volume data structure to render novel viewpoints, which can be implemented using the computing device of FIG. 1.

FIG. 3 shows an example plenoptic volume data structure and a comparison with three other data structures for representing a scene, which can be implemented using the computing device of FIG. 1.

FIG. 4 shows an example training loop of a plenoptic volume data structure model, such as the model depicted in FIG. 2.

FIGS. 5A and 5B show example pipelines for the training stage and the rendering stage of a plenoptic volume data structure model, such as the model depicted in FIG. 2.

FIG. 6 shows an example method for rendering a volume data structure, which can be implemented using the computing device of FIG. 1.

FIG. 7 shows an example method for performing ray-marching, which can be implemented using the computing device of FIG. 1.

FIG. 8 shows an example method for generating a volume data structure using machine learning, which can be implemented using the computing device of FIG. 1.

FIG. 9 shows a chart comparing training speeds of an example plenoptic volume data structure model, such as the model depicted in FIG. 2, and three other approaches.

FIG. 10 shows a table illustrating a quantitative comparison between an example plenoptic volume data structure model, such as the model depicted in FIG. 2, and three other approaches.

FIG. 11 shows a table illustrating a comparison between different data structures used in three different models, including the model depicted in FIG. 2.

FIG. 12 shows a table illustrating ablation studies for an example plenoptic volume data structure model, such as the model depicted in FIG. 2.

FIG. 13 schematically shows a non-limiting embodiment of a computing system 1300 that can enact one or more of the methods and processes described above, such as the computing device of FIG. 1.

### DETAILED DESCRIPTION

NeRFs provide for scene reconstruction and rendering of said scene from a novel viewpoint using a sparse set of input images. This promising technology provides a suitable platform for new applications, including content creation technologies used in multimedia, AR/VR, video games, movies, etc. For example, general text-to-3D synthesis methodologies have been proposed based on NeRF. However, one difficult area in deploying NeRF techniques includes real-time applications due to NeRF's computational requirements. Example real-time applications include AR/VR applications, mobile applications, etc. Rendering a view from a trained NeRF typically involves up to millions of inference calculations by neural networks, which is too computationally expensive in time and resources for real-time applications. For example, rendering a 600×800 image from a trained NeRF can take more than ten minutes using current NeRF techniques.

Although pre-computations may be used to accelerate the rendering time, such methods often use additional memory space to store these pre-computation results, which can limit the applications. For a 600×800 pixel resolution image, runtime memory consumption can be as high as six gigabytes (GB), which can be unsuitable, for example, in mobile phone applications, especially when the scene is complex. For methods that utilize the 3D sparsity nature of our world, real-time rendering and small storage overhead can be achieved, but the training time is prohibitively extensive as such methods involve first training as a typical NeRF or a dense grid, and then converting it to a sparse representation.

In view of the observations above, the present disclosure provides for memory-efficient volume data structures for novel viewpoint rendering. A NeRF representation method can be implemented using a sparse volume data structure. In some implementations, the volume data structure is based on sparse voxels, which is pre-computed and stored as a sparse volume data structure called volumetric dynamic B+ trees (VDB). VDBs are hierarchical data structures for sparse volumes that enable compact data representation and efficient random and spatially coherent data access, making it suitable for NeRF data interpolation and ray casting. Furthermore, implementation of VDBs can reduce the size of the model without reducing the accuracy and speed of computation. This enables control of the size of the model and, consequently. control of runtime memory and video card memory consumption.

In some implementations, a plenoptic VDB (PlenVDB) methodology is implemented to directly learn the VDB data structure from a set of input images with known viewpoints using a novel training strategy without additional conversion steps, enabling a compact model that can accelerate both the training and inference processes compared to current NeRF techniques. The trained data structure can then be used for real-time rendering. Such methodologies enable implementations that, compared to current NeRF techniques, converge faster in the training process, provide a more compact data format for NeRF data presentation, and render more efficiently on commodity graphics hardware. For example, a PlenVDB implementation can achieve 30+ frames per second (fps) at 1280×720 pixel resolution in some mobile applications. The trained data structure can be used in traditional graphics pipelines without additional hardware requirements. For example, the trained data structure can be exported for use in graphics shaders that enable mobile real-time rendering for a NeRF model.

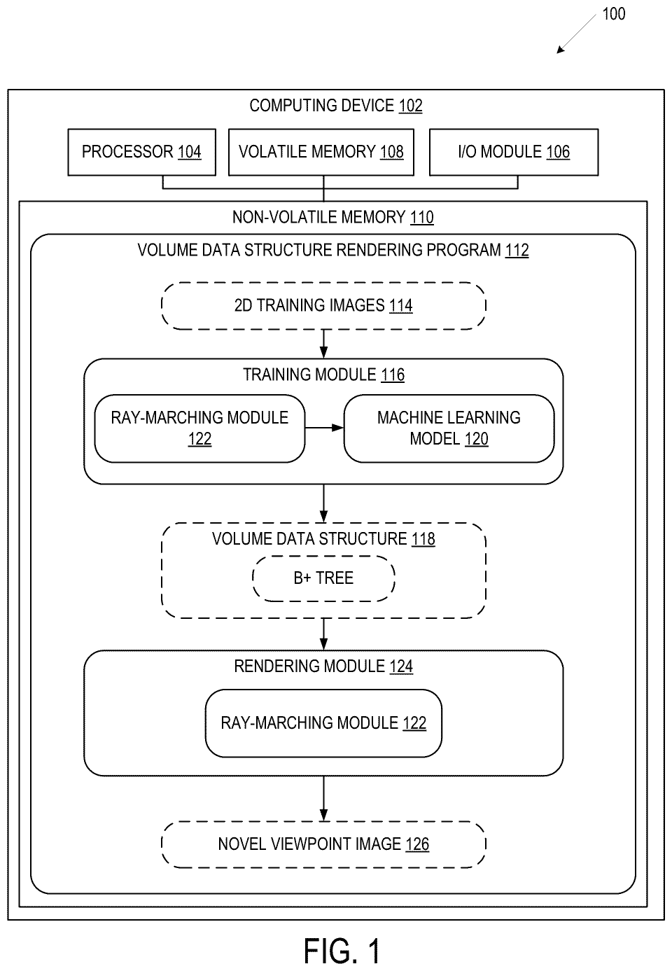

FIG. 1 shows an example computing system 100 for training and rendering novel viewpoints from two-dimensional images. The computing system 100 includes a computing device 102. The computing device 102 includes a processor 104 (e.g., central processing units, or “CPUs”), an input/output (I/O) module 106, volatile memory 108, and non-volatile memory 110. The different components are operatively coupled to one another. The non-volatile memory 110 stores a volume data structure rendering program 112, which contains instructions for the various software modules described herein for execution by the processor 104.

Upon execution by the processor 104, the instructions stored in the volume data structure rendering program 112 cause the processor 104 to initialize the process for rendering a novel viewpoint. The process starts with receiving a plurality of 2D training images 114. The 2D training images 114 depict an object or a scene from multiple different viewpoints. Various image formats can be used. The 2D training images 114 can be provided through various sources, including but not limited to local and external devices.

The volume data structure rendering program 112 includes a training module 116 that receives the 2D training images 114 to generate a volume data structure 118. The volume data structure 118 can be of any format. The volume data structure 118 can be a sparse volume data structure that contains information describing a plurality of voxels representing the object depicted in the 2D training images 114. In some implementations, the volume data structure 118 is a VDB. For example, the volume data structure 118 can be a hierarchical data structure, such as a B+ tree that includes root nodes, internal nodes, and leaf nodes. In such implementations, the B+ tree can store voxel information in its leaf nodes. The B+ tree can be implemented with any fixed height and, accordingly, any fixed depth. In some implementations, the B+ tree has a height between three and six. In further implementations, the B+ tree has a height of four—i.e., the B+ tree contains three internal node layers.

The volume data structure 118 can be generated using various processes. For example, the volume data structure 118 can be generated using deep learning techniques. In the depicted example, the volume data structure 118 is generated using a machine learning (ML) model 120. Any type of machine learning architectures can be implemented, including but not limited to artificial neural networks. The ML model 120 generates the volume data structure 118 by first initializing one or more volume data structures. The ML model 120 uses the 2D training images 114 as input to iteratively train and refine the initialized data structures. A ray-marching module 122 is used in combination with the initialized data structure to generate renderings that can be used to compare with the ground truth 2D training images 118. The comparisons are used to compute loss values and gradients that can be used to iteratively update the initialized data structures. After a predetermined number of iterations is completed, the volume data structure 118 is generated such that the data contained in the data structure can be used to provide a 3D representation of the object or scene in the 2D training images 114.

The volume data structure 118 can be used for various applications. In some implementations, the volume data structure 118 is exported to external devices. In the depicted example, the volume data structure 118 is utilized by the computing device 102 to render images of the object represented by the volume data structure 118 in a novel viewpoint. The volume data structure rendering program 112 includes a rendering module 124 for rendering an image 126 of the volume data structure 118 in a specified viewpoint. Generally, the rendered final image 126 is of a novel viewpoint different from the 2D training images 114. The final image 126 can be rendered through various methods. In the depicted example, the rendering module 124 includes a ray-marching module 122 that can be used with the volume data structure 118 to determine color values used to render the final image 126.

The computing device 102 can be configured differently depending on the application. For example, the computing device 102 can be configured to only generate the volume data structure 118 from the plurality of 2D training images 114. The volume data structure 118 can be exported to other devices for various applications, such as real-time rendering applications. In other implementations, the computing device 102 is configured to receive a volume data structure 118 and to render the novel viewpoint image 126, the viewpoint of which can be specified by the user or an application rendering the object in real-time.

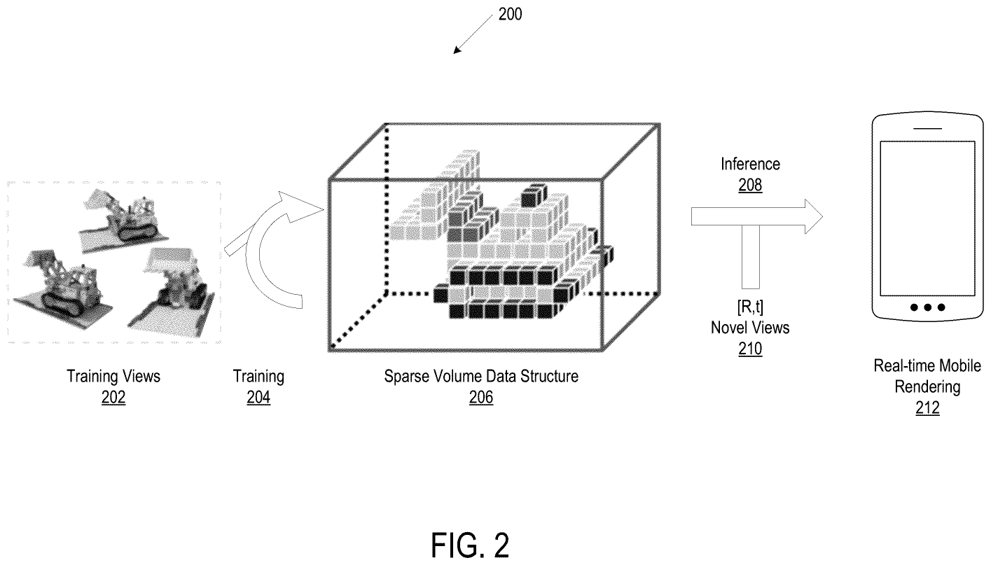

FIG. 2 shows an example model 200 for implementing and training a VDB data structure to render novel viewpoints. The model 200 starts with training views 202. which is typically provided in the form of 2D images. In the depicted example, the training views 202 depict the same bulldozer object in different viewpoints. A training process 204 is implemented to generate a volume data structure 206 from the training views 202. For example, the training process 204 can be implemented to generate a sparse volume data structure that includes data describing attributes (such as color, density, spatial location, etc.) of voxels that can be used to provide a 3D representation of the bulldozer. At inference time 208, the trained volume data structure can be used to generate novel viewpoint images. In a typical application, inputs 210 with information describing the viewpoint to be rendered is provided, and the viewpoint is rendered accordingly and provided for use in various applications, such as a real-time rendering application 212 implemented on a mobile device. Specific methods for training and rendering volume data structures are described below in further detail.

Classical NeRF models a scene as a multilayer perceptron (MLP) Φ that predicts the color c and density o of a given position p=(x, y, z) from a given direction d:

$$Φ ( p , d ) = ( σ ∈ ℝ , c ∈ {ℝ}^{3} ) \qquad ( 1 )$$

To render a pixel, NeRF samples N points {pᵢ}ᵢ₌₁^{N} along a ray r. Then, the corresponding density {σᵢ}ᵢ₌₁^{N} and color feature {cᵢ}ᵢ₌₁^{N} are predicted from the NeRF model. The color of the pixel Ĉ(r) is calculated by accumulating all samples:

$$\hat{C} ( r ) = {\sum }_{i = 1}^{N} {T}_{i} ( 1 - exp ( - {δ}_{i} {σ}_{i} ) ) {c}_{i} \qquad ( 2 )$$

$${T}_{i} = exp ( - {\sum }_{j = 1}^{i = 1} {δ}_{i} {σ}_{i} ) \qquad ( 3 )$$

where δᵢ is the distance between adjacent sampled points. During training, the loss function is defined by the mean squared error between ground truth C(r) and predicted color Ĉ(r). The loss [symbol] can be defined as:

$$ℒ = \frac{1}{\vert R \vert} {\sum }_{r ∈ R} {‖ C ( r ) - \hat{C} ( r ) ‖}_{2}^{2} \qquad ( 4 )$$

where R is the set of sampled rays in a batch.

Implementation of a VDB in a NeRF model includes the use of a sparse volume data structure. The VDB can be implemented as a B+ tree data structure that includes root nodes, internal nodes, and leaf nodes. Data is stored in the leaf nodes as spatially coherent voxels and tiles, where a tile is a larger region containing multiple voxels with one value. Voxels and tiles can have an active or inactive state, indicating whether the corresponding value is interesting or not. If a voxel or tile is inactive, the corresponding coordinate is regarded as empty space. Use of a VDB typically consumes as much memory as is required to represent active voxels while maintaining the flexibility and performance characteristics of a typical dense volumetric data structure.

The VDB can be implemented as a B+ tree of any fixed height and, accordingly, any fixed depth. In some implementations, the VDB is a B+ tree with a height between three and six. In further implementations, the VDB is a B+ tree with a height of four—i.e., the B+ tree contains three internal node layers. Since the VDB has a fixed depth, random access can be very fast (on average constant time). Additionally, the VDB can use accessors for high performance sequential access which enables fast queries for neighboring nodes.

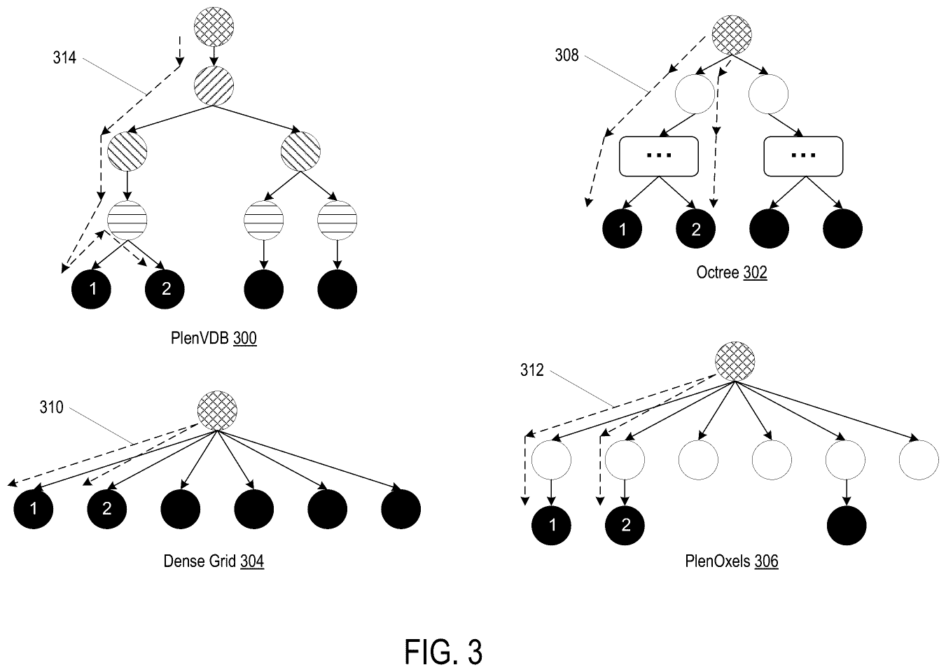

FIG. 3 shows an example PlenVDB data structure 300 and a comparison with three other data structures 302, 304, and 306 for representing a scene. The octree data structure 302 is a tree in which each internal node has eight children. Other n-ary trees can also be implemented. The octree data structure 302 generally uses the least memory out of the four data structures 300-306 as it can prune all empty voxels. Conversely, the dense grid data structure 304 is a tree of height one that generally uses the most memory as an item of memory is used for each voxel. The plenoptic volume elements (PlenOxels) data structure 306 and the PlenVDB data structure 300 provide compromises between the octree 302 and dense grid 304 data structures. PlenOxels 306 stores voxels with density and spherical harmonic coefficient information in a tree of height two, and PlenVDB 300 stores voxels in the leaf nodes of a B+ tree of a fixed height. In the depicted example, the PlenVDB 300 is a B+ tree with a fixed height of four.

Access times for the leaf nodes within dense grid 304 and PlenOxels 306 data structures are constant (O(1)). For octree data structures 302, the time complexity of accessing a leaf node becomes O(log n). For PlenVDB 300, access times to a leaf node is on average O(1) as the data structure contains a fixed height. In some applications (e.g., trilinear interpolation and ray marching), access to neighbor nodes is often performed. The search path for two adjacent voxels (numbered “1” and “2”, successively) includes returning to the root node for the octree 302, dense grid 304, and PlenOxels 306 data structures, as respectively shown by dashed lines 308, 310, and 312. For the PlenVDB data structure 300, accessors can be used for sequential access, which enables fast neighboring node queries as shown by dashed line 314.

Training of PlenVDB models can be performed using deep learning techniques. In some implementations, the training of such models includes a multi-stage process. In the depicted example, the training is performed in two stages, a coarse training process and a fine training process. In the coarse training stage, two grids are created to store density and color information, respectively. Each grid has a sufficiently large bounding box [Bₘᵢₙ^{c}, Bₘₐₓ^{c}], where Bₘᵢₙ^{c}, Bₘₐₓ^{c} are determined based on the training dataset. During the coarse training stage, a tighter bounding box [Bₘᵢₙ^{f}, Bₘₐₓ^{f}] can be extracted. In the fine training stage, two other grids for storing density and color information, respectively, are created according to the tighter bounding box. After the fine training stage, a final model is outputted.

Different density thresholds t can be set for the coarse and fine training stages. For example, in some implementations, density threshold τ is set to 10⁻⁷ and 10⁻⁴ for coarse and fine training stages, respectively. The coarse and fine training stages can be run for any number of iterations. In some implementations, the coarse training stage is run for less iterations than the fine training stage. In further implementations, the coarse training stage is run for 5,000 iterations, and the fine training stage is run for 20,0000 iterations. In each training stage, during one epoch, rays are cast from the camera, and points on the ray are sampled. The number of rays cast for each epoch can vary. In some implementations, a batch size of 8,192 rays is utilized. Based on the density and color information of the sampled points, a pixel value can be obtained and compared with the training data. The differences between the two can be used to update the density and color information of the VDB model in an iterative manner.

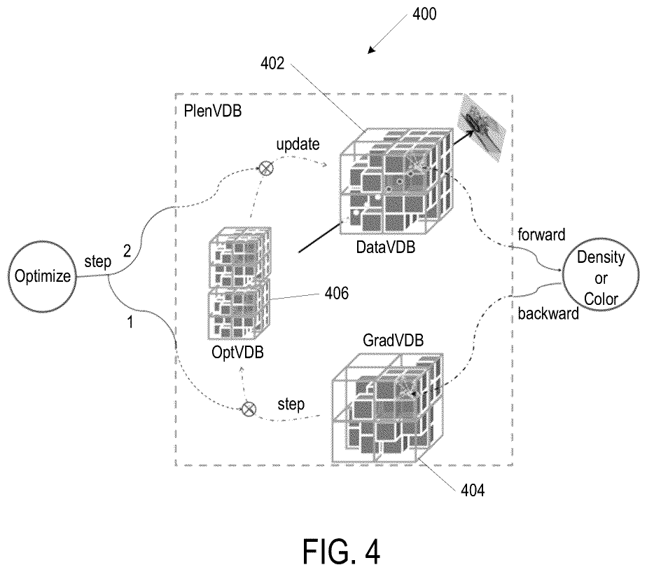

FIG. 4 shows an example training loop 400 of a PlenVDB model. During initialization, VDB data structures DensityVDB and ColorVDB are created to store the density σ∈ [symbol] and color feature c∈ [symbol] ^{3×n}, respectively. In the depicted example, DensityVDB and ColorVDB are represented as a single VDB data structure, Data VDB 402. Another VDB data structure, GradVDB 404, is also created with the same size to store the gradient that is used in the back-propagation calculation for training and iteratively updating the Data VDB 402.

For the forward training process, rays are cast from a camera view for rendering the object represented by the PlenVDB model. For each ray, a batch of coordinate {(xᵢ, yᵢ, zᵢ)}=1 along the ray is provided, and values from ColorVDB and DensityVDB can be queried to get {σᵢ}ᵢ₌₁^{N} and {cᵢ}ᵢ₌₁^{N}, respectively. For each querying coordinate, trilinear interpolation can be used. Querying neighbor nodes in VDB data structures can be performed more efficiently compared to other data structures (See FIG. 3 and accompanying description). In some implementations, values for eight neighboring voxels are queried and used for the trilinear interpolation. Coordinates outside the bounding box can result in the pixel value being set to a background value, such as zero for example. From {{σᵢ}ᵢ₌₁^{N} and {cᵢ}ᵢ₌₁^{N}, the volume rendering can be performed to produce color values for a given pixel.

Loss can be calculated from the produced pixel values and the training dataset. Different loss functions, such as L1 and L2 loss functions can be utilized. In some implementations, the loss is defined as the mean squared error. Gradients can then be calculated from the loss values and provided to the GradVDB 404. During the back-propagation process, values in the GradVDB 404 can be passed to another sparse volume data structure, OptVDB 406, which is used for storing the optimizer's parameters. The OptVDB 406 can then guide the updating process for the ColorVDB and the DensityVDB. The process can continue iteratively for a predetermined number of iterations or until the model converges based on a predetermine criterion.

Rendering of a trained VDB model can be performed in various ways. Rays can be cast from a camera view, and points along the rays are sampled. Previous methodologies involve dense sampling of points along a given ray, resulting in unnecessary computation and long rendering time. In a PlenVDB model, the sparsity of the model can be exploited to reduce computation and rendering time. The process starts with sampling a set of possible points N_{posb} for a given ray. Queries are made to DensityVDB to get density values corresponding to the points N_{posb}. Non-absolute density values enable rendering of non-opaque, translucent objects. Alpha thresholding is performed to filter out extraneous points from the set of possible points N_{posb}, resulting in a set of valid points N_{valid}. For example, the set of possible points N_{posb} can be filtered to remove points outside the bounding box, points below a density threshold, and/or points not reached due to an accumulated density threshold from previous valid points along the ray. Generally, the filtering process greatly reduces computational runtime as the sparsity of the data structure can result in a reduction of points by more than an order of magnitude, depending on the complexity of the object to be rendered. Queries to ColorVDB can be performed for the valid points N_{valid}, and a final pixel color value can be provided. Computation of the final pixel color value can be performed in various ways. In some implementations, a lightweight MLP mapping is performed to compute the final pixel color value from the queries to ColorVDB for the valid points N_{valid}. Various types of MLPs can be used. In some implementations, a shallow MLP layer including two hidden layers with 128 channels is utilized.

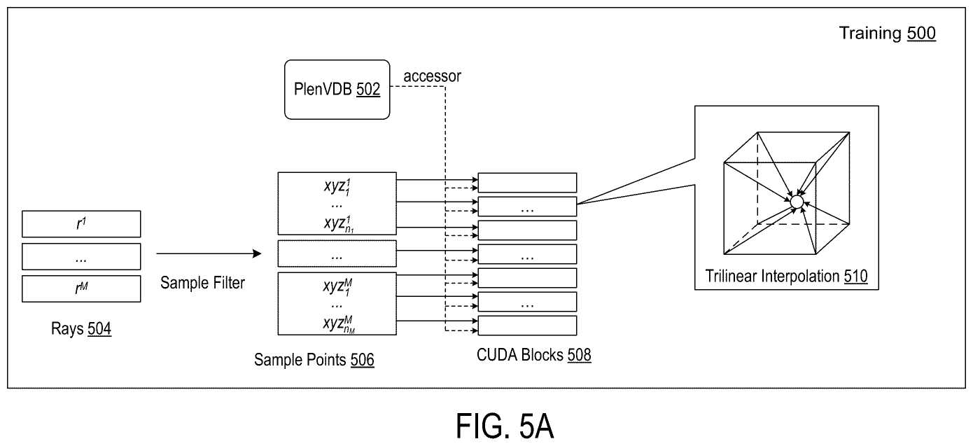

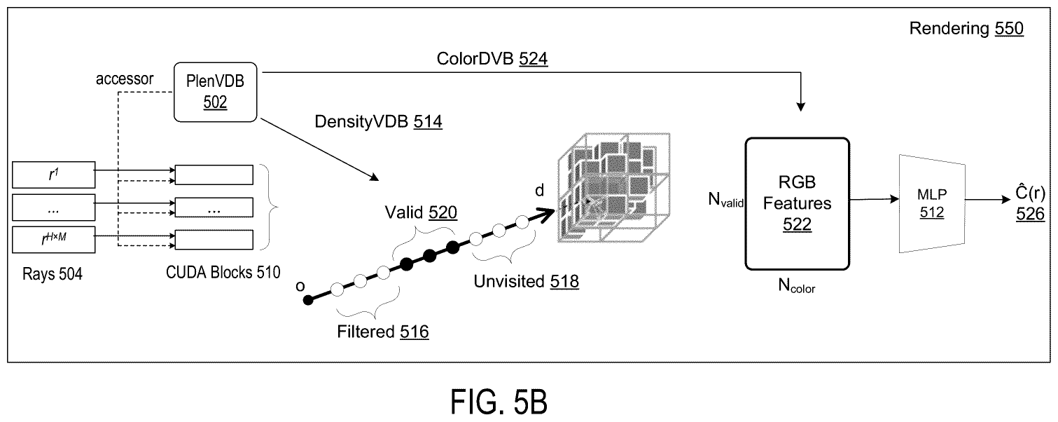

FIGS. 5A and 5B show example pipelines for the training stage 500 and the rendering stage 550 of a PlenVDB model 502. The training stage 500 employs a ray-marching algorithm to perform the training process. The process started with determining a plurality of rays 504 based on a specified viewpoint. For each ray r=o+td, tₘᵢₙ and tₘₐₓ can be estimated according to the bounding box. Points 506 (x, y, z) can be sampled along the ray r, starting from tₘᵢₙ and incrementing with a step size Δt. Any step size Δt can be used. In some implementations, a step size Δt of half of the voxel size is used, which can ensure that the nearest neighbor of the next query will change. In a first ray-marching step, each sample point is used to query the PlenVDB model 502 for a density value. Sample points outside of the bounding box or below a density threshold τ can be dropped. When t reaches tₘₐₓ or the accumulated weight is larger than a threshold, the ray-marching process can be terminated. Each point 506 can be evaluated using a separate CUDA (Compute Unified Device Architecture) block 508. For each point 506, trilinear interpolation 510 can be performed. In a second ray-marching step, the remaining sample points are used to query the PlenVDB for color features, which can be used to generate color values used for comparison against training data.

The rendering model 550 also employs a ray-marching algorithm to accelerate. With the use of a lightweight MLP 512, ray-marching can be performed twice to enable fast CUDA acceleration. For the first ray-marching step, points (x, y, z) can be sampled along each ray r, starting from tₘᵢₙ and incrementing with a step size Δt. For each sample point, DensityVDB 514 is queried to provide density values. Sample points outside of the bounding box 516 or below a density threshold τ can be dropped. When t reaches tₘₐₓ or the accumulated weight is larger than a threshold, the ray-marching process can be terminated, and successive points 518 are unvisited. Valid sample points 520, including t_{first} (the first valid sample point) can be recorded and used to skip non-valid points for the second ray-marching step.

For the second ray-marching step, an N_{valid}×3n buffer is created and the color features 522 in ColorVDB 524 are written to it for each valid sample point. Different implementations may utilize different numbers of color features. In some implementations, the color features 522 have twelve dimensions (i.e., n=4). An N_{valid}×1 can also be created to record the weight value for each valid sample point. Then, MLP mapping in CUDA can be implemented to map the 3n vector to a 3D RGB color 526.

To reduce the impact of topology redundancy, DensityVDB and ColorVDB can be merged into one data structure. Specifically, the total number of voxels filtered by a mask grid is first determined, denoted as nVoxels, and an (nVoxels+1)×(1+3n) buffer is created, denoted as M_{vdb}, where 3n is the dimension of data in ColorVDB. The values in DensityVDB can then be transferred to an index and copied to M_{vdb}. Before merging, 1+n searches can be performed on DensityVDB and ColorVDB to acquire the information.

After merging, information of both DensityVDB and ColorVDB can be stored on a single VDB. Merging DensityVDB and ColorVDB can cause pruning of inactive voxels, which may cause peak signal-to-noise ratio (PSNR) to slightly drop as the value of some inactive voxels may be useful in trilinear interpolation. The PlenVDB model can also be further compressed using various techniques. In some implementations, values are stored in a float16 format and converted to a float32 format when read.

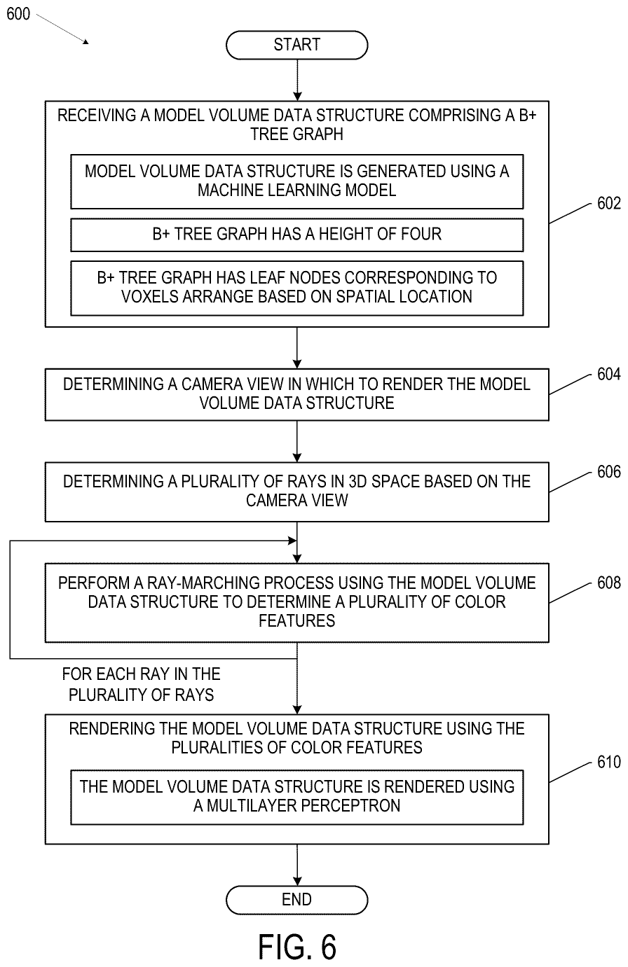

FIG. 6 shows an example method 600 for rendering a VDB structure. The method 600 includes, at step 602, receiving a model volume data structure. The model volume data structure can be received from various sources, including external devices. In some implementations, the model volume data structure is provided by a local device. The model volume data structure can be generated using various methods. Example processes include use of deep learning to generate the model volume data structure from a series of 2D training images. For example, a machine learning model can be implemented to receive 2D training images and directly generate the model volume data structure.

The model volume data structure can be of any format. For example, the model volume data structure can be a sparse volume data structure that includes information describing sparse voxels. In some implementations, the model volume data structure is a B+ tree graph, with data describing voxels stored in its leaf nodes. The data can be arranged based on the spatial location of the voxels. The B+ tree can be of any height. In some implementations, the B+ tree has a height between three and six. In further implementations, the B+ tree has a height of four.

At step 604, the method 600 includes determining a camera view in which to render the model volume data structure. The viewpoint in which to render the model volume data structure can be provided by a user or an application implementing the rendering process described herein. For example, an application configured to render an object or a scene in real-time can continuously provide the viewpoint information used to render the model volume data structure such that it can be viewed in 3D in real-time.

At step 606, the method 600 includes determining a plurality of rays in three-dimensional space based on the camera view. Different numbers of rays can be utilized depending on the desired quality of the rendered image and the desired rendering speed. More rays can result in higher quality images but longer rendering times. In some implementations, 8,192 rays are used to render a viewpoint.

At step 608, the method 600 includes, for each ray in the plurality of rays, performing a ray-marching process. The ray-marching process can include a two-stage process that first sample points along a ray to determine density values. The second stage makes use of the density values to determine which sample points are valid. Queries to the model volume data structure are made for the valid sample points to receive color features. Each ray results in a plurality of color features.

At step 610, the method 600 includes rendering the model volume data structure using the pluralities of color features. The pluralities of color features can be accumulated to generate color values that can be used to render the final image. Depending on the ray from which the color features are derived, a pixel color value can be determined accordingly. Additionally, density information can be used to adjust the color features.

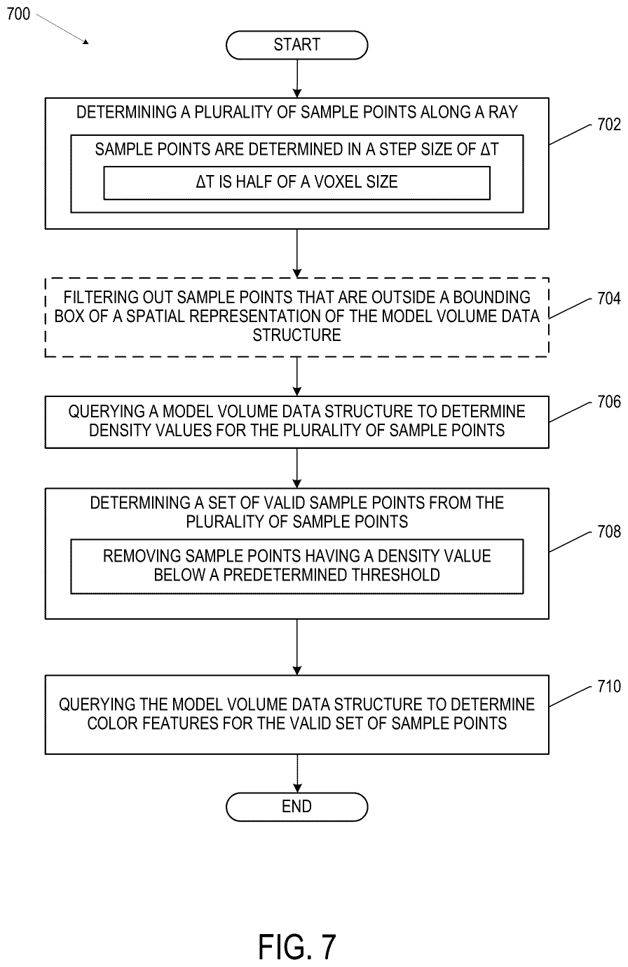

FIG. 7 shows an example method 700 for performing ray-marching. The method 700 includes, at step 702, determining a plurality of sample points. The sample points are points along the ray on which the ray-marching process is performed. For a given ray r=o+td, tₘᵢₙ and tₘₐₓ can be estimated according to the bounding box. The sample points (x, y, z) can be sampled along the ray r, starting from tₘᵢₙ and incrementing with a step size Δt. Any step size Δt can be used. In some implementations, a step size Δt of half of the voxel size is used.

At step 704, the method 700 optionally includes filtering out sample points. Sample points not meeting predetermined criteria can be filtered out. In some implementations, sample points spatially located outside of a bounding box are filtered out. The bounding box can be determined based on the model volume data structure that is to be rendered. The bounding box is a box in 3D space in which the voxels of the model volume data structure is contained.

At step 706, the method 700 includes querying a model volume data structure to determine density values for the plurality of sample points. If step 704 is performed, the model volume data structure is queried to determine density values for the remaining sample points. The querying process can terminate prematurely if the accumulated density values are above a predetermined threshold, indicating that voxels beyond the termination point do not contribute to the color of the final rendering.

At step 708, the method 700 includes determining a set of valid sample points from the plurality of sample points. Valid sample points include sample points that met certain predetermined criteria. For example, valid sample points can include sample points with density values above a predetermined threshold. Additionally, valid sample points can exclude sample points that have been filtered or dropped, such as sample points determined to be outside a bounding box or sample points that are unvisited due to early termination of the querying process (as described in step 706).

At step 710, the method 700 includes querying the model volume data structure to determine color features for the set of valid sample points. The color features can be used to determine pixel color values in the final rendered image. Density values can be used in combination with the color features of the voxel to determine the voxel's effect on the final rendered image. Additionally, the order in which the sample points occur on the ray can also determine the effect of the density value.

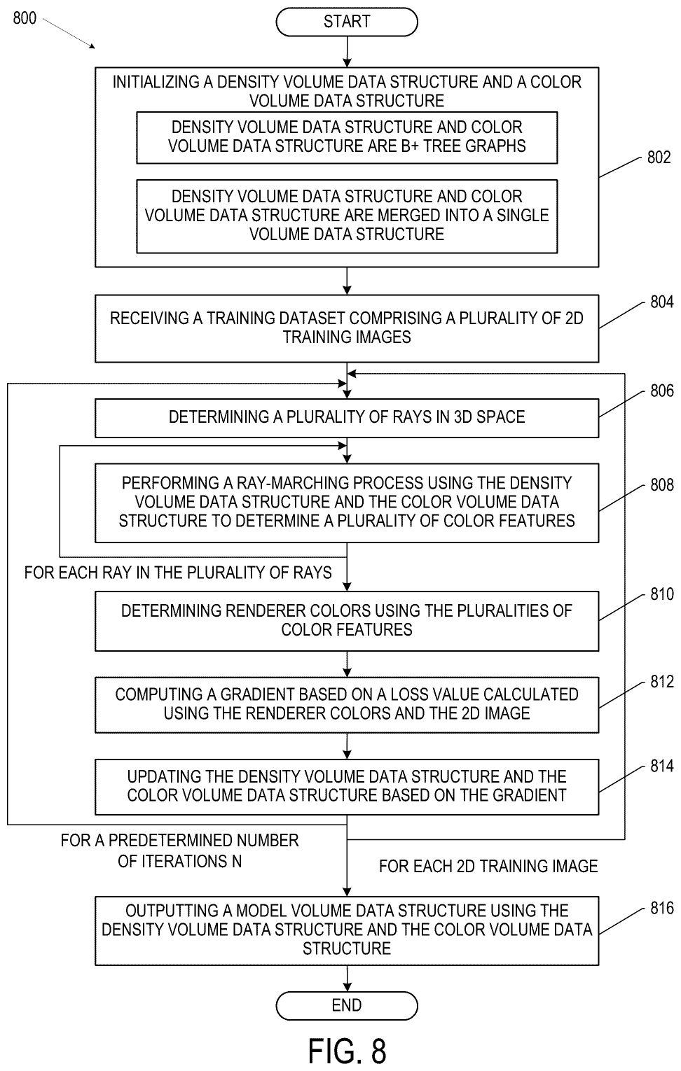

FIG. 8 shows an example method 800 for generating a VDB structure using machine learning. The method 800 includes, at step 802, initializing a density volume data structure and a color volume data structure. The density volume data structure and the color volume data structure can be of any format. In some implementations, the density volume data structure and/or the color volume data structure is a hierarchical data structure, such as a B+ tree that includes root nodes, internal nodes, and leaf nodes. The B+ tree stores voxel information in its leaf nodes. In some implementations, the B+ tree has a height between three and six. In further implementations, the B+ tree has a height of four—i.e., the B+ tree contains three internal node layers.

At step 804, the method 800 includes receiving a training dataset comprising a plurality of 2D training images. The 2D training images depict an object or a scene from multiple different viewpoints and are used to train a model volume data structure. The images can be of any image format. The 2D training images can be received through various sources, including but not limited to external devices and locally through user upload.

For each 2D training image, a training process is performed. The training process includes, at step 806, determining a plurality of rays in 3D space. The plurality of rays can be determined based on a viewpoint. Any number of rays can be utilized. More rays can result in higher image quality but slower rendering speed. In this case, more rays can result in slower training speed but faster convergence. In some implementations, 8,192 rays are used for each epoch.

The training process includes, at step 808, for each ray in the plurality of rays, performing a ray-marching process using the density volume data structure and the color volume data structure to determine a plurality of color features. The ray-marching process can be performed in various ways, including as described in FIG. 7. In some implementations, the ray-marching process includes a first stage where density values are queried from the density volume data structure for a plurality of sample points. In a second stage, color values are queried from the color volume data structure for the sample points. The sample points can be filtered to remove inconsequential points, such as sample points outside a bounding box or unvisited points that correspond to occluded voxels based on the viewpoint.

The training process includes, at step 810, determining renderer colors using the pluralities of color features. In some implementations, an MLP is used to determine color values from the color features. The color values can be used to color pixels that make up the final rendered image. In a training process, the color values can be used for comparison with the 2D training images.

The training process includes, at step 812, computing a gradient. The gradient can be calculated from loss values obtained by finding the differences between the renderer colors and the 2D training images. Different loss functions, such as L1 and L2 loss functions can be utilized. In some implementations, the loss is defined as the mean squared error.

The training process includes, at step 814, updating the density volume data structure and the color volume data structure based on the gradient. Steps 806-814 can be performed for a predetermined number of iterations for each 2D training image. As the density volume data structure and the color volume data structure are iteratively updated, they converge towards a final model volume data structure.

At step 816, the method 800 includes outputting a model volume data structure. The model volume data structure can be outputted for various applications. In some implementations, the model volume data structure is used locally for a real-time rendering application. In other implementations, the model volume data structure is output to an external device.

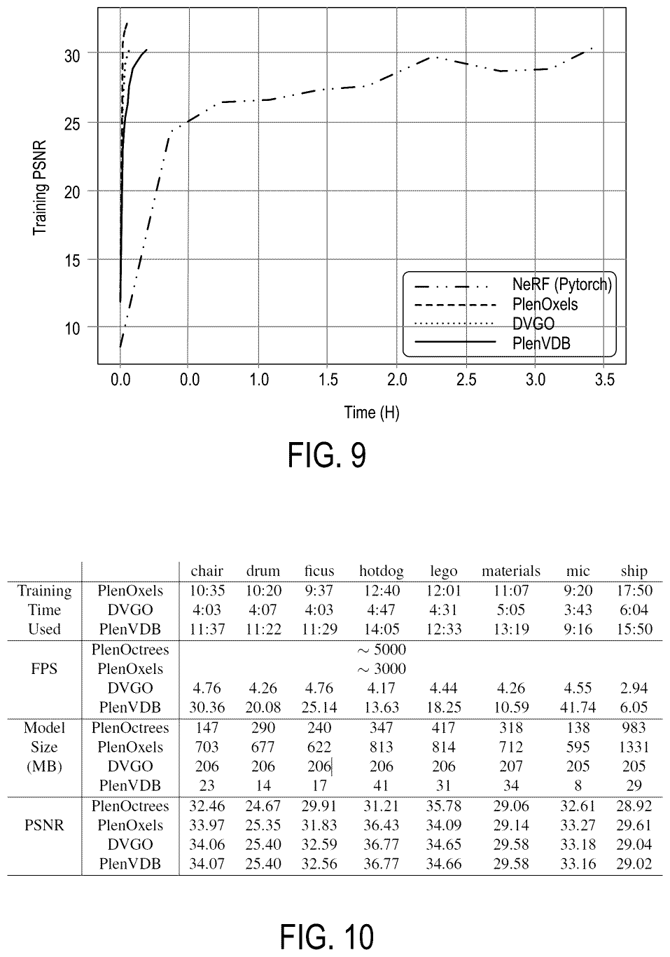

FIG. 9 shows a chart comparing training speeds of an example PlenVDB model and three other approaches. The three other approaches include a classical NeRF model and two dense-grid based approaches, a PlenOxels model and a direct voxel grid optimization (DVGO) model. The chart graphs the trend of training PSNR with time (n=4). As shown, the example PlenVDB model, the PlenOxels model, and the DVGO model outperform a classical NeRF model and are able to reach a training PSNR of thirty before 0.3 hour.

FIG. 10 shows a table illustrating a quantitative comparison between an example PlenVDB model and three other approaches. The three other approaches include a plenoptic octree (PlenOctrees) model, a PlenOxels model, and a DVGO model. Training speeds (minutes), fps numbers, model sizes (megabytes MB), and PSNR are shown for the four models across eight different scenes of various complexities (chair, drum, ficus, hotdog, lego, materials, mic, and ship). Resolutions are chosen for models to obtain similar PSNRs. Resolutions utilized for the DVGO model and the PlenVDB model is 1603, and resolutions utilized for the PlenOxels model and the PlenOctrees model is 5123.

Training time used for the example PlenVDB model shows sub-twenty minutes for training convergence across all eight scenes. Rendering speed, shown in fps values, of the example PlenVDB model outperforms the DVGO model by a factor of five on average. Rendering speeds of the PlenOctrees and PlenOxels models are much faster due to the use of spherical harmonics (SH) coefficients to represent color. These models do not use MLPs, which is the case with the example PlenVDB model and the DVGO model. As such, the example PlenVDB is capable of achieving higher image quality compared to the PlenOctrees and PlenOxels models, even at lower resolutions. Additionally, the PlenOctrees model only supports nearest neighbor interpolation, which further results in low-quality images. The rendering speeds of the PlenOxels model can be attributed to its data structures, which are close to a dense grid, allowing fast access times but large space occupation. Indeed, as shown in FIG. 7, the PlenOxels model results in the largest model size. The example PlenVDB and DVGO models are able to achieve high quality images, but the example PlenVDB model has a model size that is, on average, about ten times smaller than the DVGO model due to the use of a sparse volume data structure.

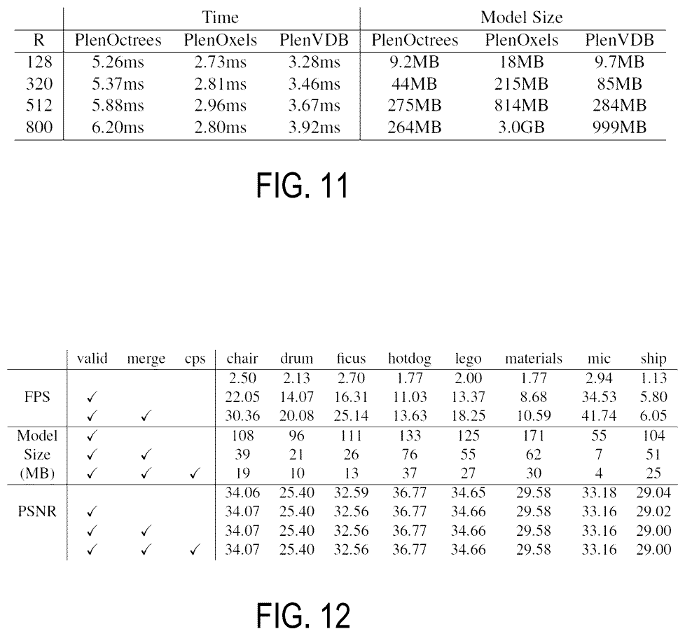

FIG. 11 shows a table illustrating a comparison between different data structures used in three different models. Voxel access times (n=800) and model sizes (MB) are shown for four different resolutions R=128, 320, 512, and 800. To ensure that the data structures represent the same scene information, the model is first trained by PlenOxels and then converted to PlenOctrees and PlenVDB. A ray-marching process is applied to query 800 points along a diagonal ray with trilinear interpolation.

For voxel access, PlenOxels utilizes a dense grid to save the pointer to data, so it is the fastest and almost constant across different resolutions. PlenOctrees takes the most time, which increases with higher resolutions. The reason is that for an octree, tree depth and scene resolution vary logarithmically in theory. As a four-depth tree, PlenVDB balances between PlenOctrees and PlenOxels. Access times for PlenVDB increase with higher resolution as lower resolutions have higher probabilities of sequential queries being close to the current voxels, which make better use of the caching mechanism of VDB.

For storage occupation, PlenOxels costs the most as a dense data structure and PlenOxels occupies the least as a deep tree. PlenVDB balances between PlenOxels and PlenOctrees and varies depending on the application. When resolution is a power of two, the model size of PlenVDB is close to PlenOctrees.

FIG. 12 shows a table illustrating ablation studies for an example PlenVDB model. Results are shown across eight different 1603 scenes. Model sizes exclude the configuration parameters and the MLPs. “Valid” refers to the rewritten rendering method regarding the valid percentage of sampled points. “Merge” refers to the operation of merging DensityVDB and ColorVDB into one VDB. “Cps” refers to the compression operation. For rendering speed (FPS), making use of the sparsity of valid sampled points achieves a tenfold improvement on average. After merging two VDBs, duplicate searches for the same topology can be reduced, resulting in further improvements. For storage, storing two VDBs can result in some topology redundancy. Merging the two VDBs can save two-thirds of memory, and the compression operation can further reduce the model size to half. For PSNR, all three optimizations have almost zero loss on the rendered image quality.

In some embodiments, the methods and processes described herein may be tied to a computing system of one or more computing devices. In particular, such methods and processes may be implemented as a computer-application program or service, an application-programming interface (API), a library, and/or other computer-program product.

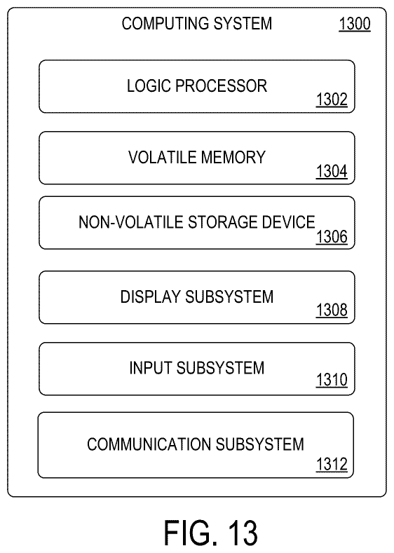

FIG. 13 schematically shows a non-limiting embodiment of a computing system 1300 that can enact one or more of the methods and processes described above. Computing system 1300 is shown in simplified form. Computing system 1300 may embody the computer device 102 described above and illustrated in FIG. 1. Computing system 1300 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1300 includes a logic processor 1302 volatile memory 1304, and a non-volatile storage device 1306. Computing system 1300 may optionally include a display subsystem 1308, input subsystem 1310, communication subsystem 1312, and/or other components not shown in FIG. 13.

Logic processor 1302 includes one or more physical devices configured to execute instructions. For example, the logic processor 1302 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 1302 may include one or more physical processors (hardware) configured to execute software instructions. Additionally or alternatively, the logic processor 1302 may include one or more hardware logic circuits or firmware devices configured to execute hardware-implemented logic or firmware instructions. Processors of the logic processor 1302 may be single-core or multi-core, and the instructions executed thereon may be configured for sequential, parallel, and/or distributed processing. Individual components of the logic processor 1302 optionally may be distributed among two or more separate devices, which may be remotely located and/or configured for coordinated processing. Aspects of the logic processor 1302 may be virtualized and executed by remotely accessible, networked computing devices configured in a cloud-computing configuration. In such a case, these virtualized aspects are run on different physical logic processors of various different machines, it will be understood.

Non-volatile storage device 1306 includes one or more physical devices configured to hold instructions executable by the logic processors to implement the methods and processes described herein. When such methods and processes are implemented, the state of non-volatile storage device ?06 may be transformed—e.g., to hold different data.

Non-volatile storage device 1306 may include physical devices that are removable and/or built-in. Non-volatile storage device ?06 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1306 may include nonvolatile, dynamic, static, read/write, read-only, sequential-access, location-addressable, file-addressable, and/or content-addressable devices. It will be appreciated that non-volatile storage device 1306 is configured to hold instructions even when power is cut to the non-volatile storage device 1306.

Volatile memory 1304 may include physical devices that include random access memory. Volatile memory 1304 is typically utilized by logic processor ?02 to temporarily store information during processing of software instructions. It will be appreciated that volatile memory 1304 typically does not continue to store instructions when power is cut to the volatile memory 1304.

Aspects of logic processor 1302, volatile memory 1304, and non-volatile storage device 1306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1300 typically implemented in software by a processor to perform a particular function using portions of volatile memory, which function involves transformative processing that specially configures the processor to perform the function. Thus, a module, program, or engine may be instantiated via logic processor 1302 executing instructions held by non-volatile storage device 1306, using portions of volatile memory 1304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1308 may be used to present a visual representation of data held by non-volatile storage device 1306. The visual representation may take the form of a graphical user interface (GUI). As the herein described methods and processes change the data held by the non-volatile storage device, and thus transform the state of the non-volatile storage device, the state of display subsystem 1308 may likewise be transformed to visually represent changes in the underlying data. Display subsystem 1308 may include one or more display devices utilizing virtually any type of technology. Such display devices may be combined with logic processor 1302, volatile memory 1304, and/or non-volatile storage device 1306 in a shared enclosure, or such display devices may be peripheral display devices.

When included, input subsystem 1310 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1312 may be configured to communicatively couple various computing devices described herein with each other, and with other devices. Communication subsystem 1312 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1300 to send and/or receive messages to and/or from other devices via a network such as the Internet.

The following paragraphs provide additional description of the subject matter of the present disclosure. One aspect provides a computing device for rendering a model volume data structure, the computing device comprising a processor coupled to a storage medium that stores instructions, which, upon execution by the processor, cause the processor to store the model volume data structure, wherein the model volume data structure comprises a B+ tree graph, determine a camera view in which to render the model volume data structure, determine a plurality of rays in three-dimensional space based on the camera view, for each ray in the plurality of rays, perform a ray-marching process using the model volume data structure to determine a plurality of color features, and render the model volume data structure using the pluralities of color features. In this aspect, additionally or alternatively, the model volume data structure is generated by a machine learning model. In this aspect, additionally or alternatively, the machine learning model uses a plurality of two-dimensional images to generate the model volume data structure. In this aspect, additionally or alternatively, performing the ray-marching process for a ray in the plurality of rays comprises determining a plurality of sample points along the ray, querying the model volume data structure to determine density values for the plurality of sample points, determining a valid set of sample points from the plurality of sample points by removing sample points having a density value below a predetermined threshold, and querying the model volume data structure to determine the color features for the valid set of sample points. In this aspect, additionally or alternatively, performing the ray-marching process further comprises filtering out sample points in the plurality of sample points that are outside a bounding box of a spatial representation of the model volume data structure. In this aspect, additionally or alternatively, performing the ray-marching process further comprises terminating the querying of the model volume data structure to determine the density values for the plurality of sample points if an accumulated density threshold is reached. In this aspect, additionally or alternatively, a successive query to an adjacent voxel is performed without traversing a root node of the B+ tree graph. In this aspect, additionally or alternatively, rendering the model volume data structure using the pluralities of color features comprises using a multilayer perceptron. In this aspect, additionally or alternatively, the B+ tree graph has a height of four. In this aspect, additionally or alternatively, leaf nodes of the B+ tree graph correspond to voxels, and wherein the B+ tree graph is arranged based on spatial locations of the voxels.

Another aspect provides a method for rendering a model volume data structure, the method comprising receiving the model volume data structure, wherein the model volume data structure comprises a B+ tree graph, determining a camera view in which to render the model volume data structure, determining a plurality of rays in three-dimensional space based on the camera view, for each ray in the plurality of rays, performing a ray-marching process using the model volume data structure to determine a plurality of color features, and rendering the model volume data structure using the pluralities of color features. In this aspect, additionally or alternatively, the model volume data structure is generated by a machine learning model using a plurality of two-dimensional images. In this aspect, additionally or alternatively, performing the ray-marching process for a ray in the plurality of rays comprises determining a plurality of sample points along the ray, querying the model volume data structure to determine density values for the plurality of sample points, determining a valid set of sample points from the plurality of sample points by removing sample points having a density value below a predetermined threshold, and querying the model volume data structure to determine the color features for the valid set of sample points. In this aspect, additionally or alternatively, performing the ray-marching process further comprises filtering out sample points in the plurality of sample points that are outside a bounding box of a spatial representation of the model volume data structure and terminating the querying of the model volume data structure to determine the density values if an accumulated density threshold is reached. In this aspect, additionally or alternatively, the B+ tree graph has a height of four; leaf nodes of the B+ tree graph corresponds to voxels; and the B+ tree graph is arranged based on spatial locations of the voxels.

Another aspect provides a computing device for generating a model volume data structure, the computing device comprising a processor coupled to a storage medium that stores instructions, which, upon execution by the processor, cause the processor to initialize a density volume data structure and a color volume data structure, receive a training dataset comprising a plurality of two-dimensional images, for each two-dimensional image in the plurality of two-dimensional images, training the density volume data structure and the color volume data structure by performing a predetermined number of iterations of a training process, wherein each iteration comprises determining a plurality of rays in three-dimensional space, for each ray in the plurality of rays, performing a ray-marching process using the density volume data structure and the color volume data structure to determine a plurality of color features, determining renderer colors using the pluralities of color features, computing a gradient based on a loss value calculated using the renderer colors and the two-dimensional image, and updating the density volume data structure and the color volume data structure based on the gradient, and output the model volume data structure using the density volume data structure and the color volume data structure. In this aspect, additionally or alternatively, the training process further comprises a coarse training stage for determining a bounding box in three-dimensional space in which the ray-marching processes are performed. In this aspect, additionally or alternatively, the density volume data structure and the color volume data structure are merged into a single volume data structure. In this aspect, additionally or alternatively, performing a ray-marching process comprises performing trilinear interpolation. In this aspect, additionally or alternatively, the density volume data structure comprises a B+ tree graph.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device for rendering a model volume data structure, the computing device comprising:
a processor coupled to a storage medium that stores instructions, which, upon execution by the processor, cause the processor to:
store the model volume data structure, wherein the model volume data structure comprises a B+ tree graph;
determine a camera view in which to render the model volume data structure;
determine a plurality of rays in three-dimensional space based on the camera view;
for each ray in the plurality of rays, perform a ray-marching process using the model volume data structure to determine a plurality of color features; and
render the model volume data structure using the pluralities of color features.

2. The computing device of claim 1, wherein the model volume data structure is generated by a machine learning model.

3. The computing device of claim 2, wherein the machine learning model uses a plurality of two-dimensional images to generate the model volume data structure.

4. The computing device of claim 1, wherein performing the ray-marching process for a ray in the plurality of rays comprises:
determining a plurality of sample points along the ray;
querying the model volume data structure to determine density values for the plurality of sample points;
determining a valid set of sample points from the plurality of sample points by removing sample points having a density value below a predetermined threshold; and
querying the model volume data structure to determine the color features for the valid set of sample points.

5. The computing device of claim 4, wherein performing the ray-marching process further comprises filtering out sample points in the plurality of sample points that are outside a bounding box of a spatial representation of the model volume data structure.

6. The computing device of claim 4, wherein performing the ray-marching process further comprises terminating the querying of the model volume data structure to determine the density values for the plurality of sample points if an accumulated density threshold is reached.

7. The computing device of claim 4, wherein a successive query to an adjacent voxel is performed without traversing a root node of the B+ tree graph.

8. The computing device of claim 1, wherein rendering the model volume data structure using the pluralities of color features comprises using a multilayer perceptron.

9. The computing device of claim 1, wherein the B+ tree graph has a height of four.

10. The computing device of claim 1, wherein leaf nodes of the B+ tree graph correspond to voxels, and wherein the B+ tree graph is arranged based on spatial locations of the voxels.

11. A method for rendering a model volume data structure, the method comprising:
receiving the model volume data structure, wherein the model volume data structure comprises a B+ tree graph;
determining a camera view in which to render the model volume data structure;
determining a plurality of rays in three-dimensional space based on the camera view;
for each ray in the plurality of rays, performing a ray-marching process using the model volume data structure to determine a plurality of color features; and
rendering the model volume data structure using the pluralities of color features.

12. The method of claim 11, wherein the model volume data structure is generated by a machine learning model using a plurality of two-dimensional images.

13. The method of claim 11, wherein performing the ray-marching process for a ray in the plurality of rays comprises:
determining a plurality of sample points along the ray;
querying the model volume data structure to determine density values for the plurality of sample points;
determining a valid set of sample points from the plurality of sample points by removing sample points having a density value below a predetermined threshold; and
querying the model volume data structure to determine the color features for the valid set of sample points.

14. The method of claim 13, wherein performing the ray-marching process further comprises:
filtering out sample points in the plurality of sample points that are outside a bounding box of a spatial representation of the model volume data structure; and
terminating the querying of the model volume data structure to determine the density values if an accumulated density threshold is reached.

15. The method of claim 11, wherein:
the B+ tree graph has a height of four;
leaf nodes of the B+ tree graph corresponds to voxels; and
the B+ tree graph is arranged based on spatial locations of the voxels.

16. A computing device for generating a model volume data structure, the computing device comprising:
a processor coupled to a storage medium that stores instructions, which, upon execution by the processor, cause the processor to:
initialize a density volume data structure and a color volume data structure;
receive a training dataset comprising a plurality of two-dimensional images;
for each two-dimensional image in the plurality of two-dimensional images, training the density volume data structure and the color volume data structure by performing a predetermined number of iterations of a training process, wherein each iteration comprises:
determining a plurality of rays in three-dimensional space;
for each ray in the plurality of rays, performing a ray-marching process using the density volume data structure and the color volume data structure to determine a plurality of color features;
determining renderer colors using the pluralities of color features;
computing a gradient based on a loss value calculated using the renderer colors and the two-dimensional image; and
updating the density volume data structure and the color volume data structure based on the gradient; and
output the model volume data structure using the density volume data structure and the color volume data structure.

17. The computing device of claim 16, wherein the training process further comprises a coarse training stage for determining a bounding box in three-dimensional space in which the ray-marching processes are performed.

18. The computing device of claim 16, wherein the density volume data structure and the color volume data structure are merged into a single volume data structure.

19. The computing device of claim 16, wherein performing a ray-marching process comprises performing trilinear interpolation.

20. The computing device of claim 16, wherein the density volume data structure comprises a B+ tree graph.
